(19) United States
(12) Patent Application Publication
(10) Pub. No.: US 2005/0108032 A1
(43) Pub. Date: May 19, 2005

(54) Method and apparatus to account for hard copy cost

(76) Inventors: Mark M. Josephsen, Boise, ID (US); Alan Scott Walker, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/715,715

(22) Filed: Nov. 17, 2003

(51) Int. Cl. G06F 17/60

(52) U.S. Cl. 705/1; 705/400

(57) ABSTRACT

In one embodiment, a method of accounting for printing to a sheet of media in a printing device includes recording the type of media actually used, determining an amount of pigment used on the sheet of media, and calculating the cost of printing to the media by adding the cost of the sheet of media actually used and the cost of the pigment used on the sheet of media. The method also includes determining an amortized cost related to the printing device per sheet of media, and adding it to the cost of the media and the cost of the pigment.

### FIELD OF THE INVENTION

The present invention relates to printers or multi-function machines that include a printing function. In particular, the present invention relates to a method and apparatus to account for hard copy cost.

### BACKGROUND OF THE INVENTION

Some entities require the application of strict cost accounting measures before the costs associated with a printing device can be charged back to the entity. The entity could be a user, or a cost center. For example, before a government contractor can bill back all the expenses associated with a printer, the contractor has to ensure that a printer and all the consumables are used to support a government contract. As a result, hard copy cost accounting, to date, has been generally accomplished in one of two ways. A first method of cost accounting is to charge by the use of a specific device. Each device keeps track of the type of media, the size of the media, and the number of sheets of media used. The device also tracks if the page was color or monochrome, and if the printing was done on one side (simplex) or two sides (duplex). The costs of the printing device can be billed back as long as the printer supports a single contract for the entity.

Many times, a business may support more than one contract for an entity requiring cost accounting for copies. If the printing device is shared and used to support more than one contract for the entity, the costs associated with the printer may not be chargeable to the entity. In other words, going back to the example, a contractor may support the same governmental body under several different contracts. In this case, the contractor is unable to bill back the use of the shared printing device, such as copier, since the contractor can not ensure that the printing device and all the consumables it used supported a single government contract. In this case, the printer cannot be audited since there is more than one source of costs associated with the printer.

A second method of accounting is to track charges using an external device to determine who initiated the job, and to determine the purpose. Determination of the purpose generally involves the user inputting billing codes on a separate tracking device. The separate tracking device does not have any way of tracking the type of media or other aspects of the copy. The separate tracking device only counts the number of copies made at the printing device. A “click” charge is made for each copy made. The “click” charge is typically a settled upon amount that supposedly estimates the cost of the consumables and the cost of wear and tear on the printing device. For example, in making monochromic copies, the cost per page or cost per “click” may be $0.05/page while for a color copy the cost per page or cost per “click” may be $2.00. There is no way to do an actual cost accounting. This method is a very rough estimate and really is not detailed enough to be a strict cost accounting.

Still a third method used by some other machines, namely some print servers, includes parsing the print job requests as they are routed through the server and sent to various printing devices. This method has additional problems. In other words, a print server attempts to read and parse the print job requests and to determine certain aspects of the print job. This method has some major problems. Amongst the problems is that the parser in the print server is not always successful in parsing a print job. Even if the print job is successfully parsed, there is no feedback to the print server that the print job was completed. A print job can be sent to a particular printing device, but it may be cancelled. There is no way to assure an entity for whom work is being done that the print job was done, much less that the costs of the printing device were actually incurred.

### BRIEF DESCRIPTION OF THE DRAWINGS

The invention is pointed out with particularity in the appended claims. However, a more complete understanding of the present invention may be derived by referring to the detailed description when considered in connection with the figures, wherein like reference numbers refer to similar items throughout the figures and:

FIG. 1 is a perspective view of a printing device, according to an embodiment of this invention.

FIG. 2 is a schematic diagram of a computer system, portions of which are included in the printing device, according to an embodiment of this invention.

FIG. 3 is a schematic diagram of an electronic device that includes the controller and memory, according to an embodiment of the invention.

FIG. 4 is a flow chart illustrating a method of accounting for printing to a sheet of media in a printing device, according to an embodiment of this invention.

FIG. 5 is a flow chart illustrating a method of accounting for costs of printing, according to an embodiment of this invention.

FIG. 6 is a flow chart illustrating a method of determining an amount of pigment used for printing, according to an embodiment of this invention.

FIG. 7 is a flow chart illustrating a method of determining an amount of pigment used for printing, according to another embodiment of this invention.

FIG. 8 is a flow chart illustrating a method of accounting for costs of printing, according to another embodiment of this invention.

FIG. 9 is a flow chart illustrating a method of accounting for costs of printing, according to another embodiment of this invention.

FIG. 10 is a block diagram of a computer-readable medium that includes an instruction set therein, according to an embodiment of this invention.

### DETAILED DESCRIPTION OF EMBODIMENTS OF THE INVENTION

The following description and the drawings illustrate specific embodiments of the invention sufficiently to enable those skilled in the art to practice it. Other embodiments may incorporate structural, logical, electrical, process, and other changes. Examples merely typify possible variations. Individual components and functions are optional unless explicitly required, and the sequence of operations may vary. Portions and features of some embodiments may be included in or substituted for those of others. The scope of the invention encompasses the full ambit of the claims and all available equivalents. The following description is, therefore, not to be taken in a limited sense, and the scope of the present invention is defined by the appended claims.

In the various embodiments described herein, the functions described are implemented in software, hardware, firmware or a combination of the above. Software, firmware and hardware are different ways to implement logic or programming of a set of computer searchable instructions. In one embodiment, the computer readable instructions are stored on computer readable media such as memory or other type of storage devices. The term “computer readable instructions” is also used to represent carrier waves on which the executable set of instructions are transmitted. Further, such functions correspond to modules, which are software, hardware, firmware or any combination thereof. Multiple functions are performed in one or more modules as desired, and the embodiments described are merely examples.

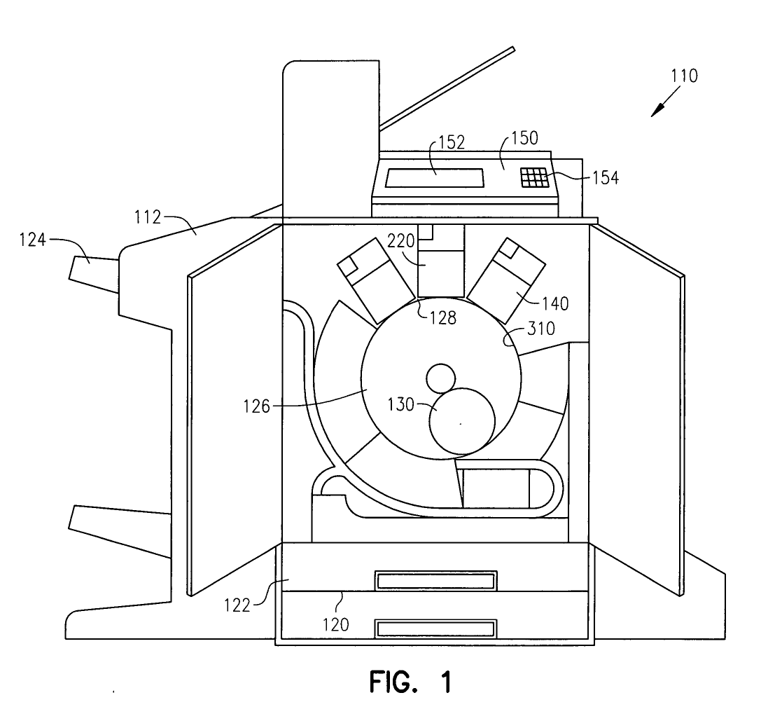

FIG. 1 shows an imaging apparatus 110 according to one embodiment of this invention. FIG. 1 includes an imaging apparatus 110, that is used in an office environment for printing business reports, correspondence, and the like. The imaging apparatus 110 is an example of an imaging apparatus. The imaging apparatus 110 is a laser toner printer or an inkjet printer. The imaging apparatus could be another type of printer scanner or facsimile machine, including dry toner-based, wax-based, or any other marking system. In addition, the imaging apparatus could be a multifunction peripheral device capable of printing, scanning and faxing. The imaging apparatus 110 includes a chassis 112 and a print media handling system 120 for supplying a print media. The print media handling system 120 includes at least one media input tray 122, a media output tray 124 and a media or paper path 126. The media or paper path includes a series of rollers 130 that position the paper to receive pigment from a pigment source 140. Pigments include toner and any other source of color forming material for creating images on media. In addition to the rollers 130, the media or paper path 126 includes a print drum 310. In other embodiments, the device may have no drum. The print drum 310 moves the paper or media into a print zone 128. The pigment source 140 is positioned near the print drum 310 in the print zone 128. In this embodiment, the pigment source 140 includes a plurality of inkjets or plurality of toner sources 220 positioned around a portion of the print drum 310. It should be understood that the pigment source 140 is not limited to a plurality of inkjets or toner sources and could be any other source of pigment. Furthermore, the print media used includes any type of suitable sheet material, such as paper, photo-quality paper, card-stock, transparencies, mylar, foils, and any other similar print media. The printing apparatus also includes a control panel 150. The control panel includes a display 152 and a keypad 154 for inputting commands to the printing apparatus 110. Parameters related to a print job are displayed on the display 152. Selections are made at the keypad 154. After a selection is made, the result is displayed on the display 152.

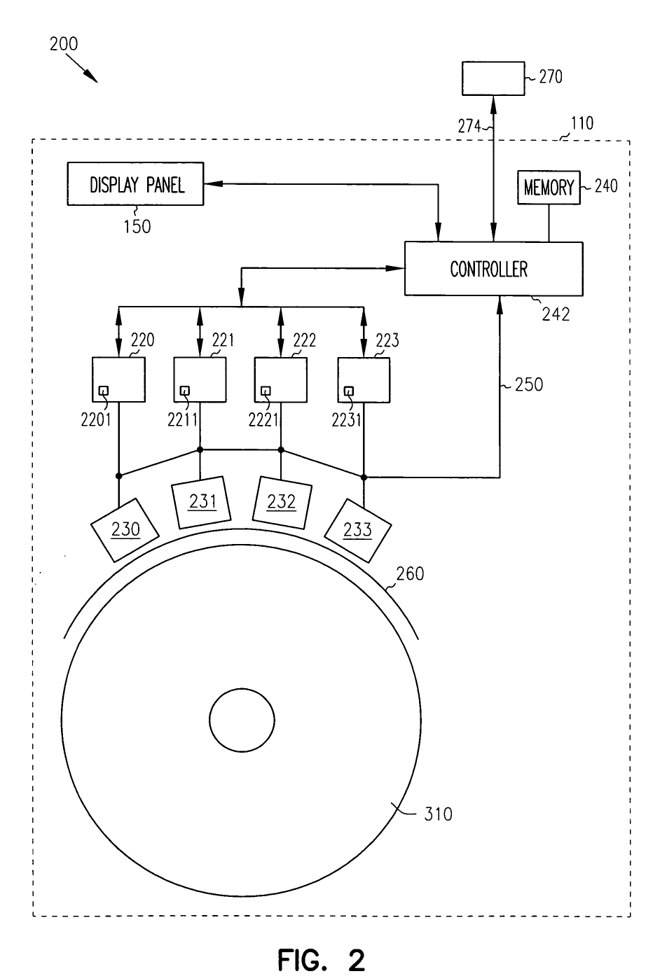

FIG. 2 is a schematic view of a printing apparatus 200 that includes the imaging apparatus 110 with a printer controller 242, according to an embodiment of the invention. A source of commands 270 is attached to the imaging apparatus 110, such as a laser toner printer or an inkjet printer, which are types of imaging apparatus 110. An imaging apparatus 110 includes any device capable of forming an image, such as a printer, scanner, facsimile machine or a combination of the above. The controller 242 generally receives instructions from the command source 270. The command source can be a host computer connected directly to the imaging apparatus or a device attached to a network. The command source 270 could also be a memory device attached to the controller, like a hard drive or flash memory. In the case of the latter, the imaging apparatus 110 is also attached to a network.

The controller 230 controls many aspects of the imaging apparatus 110. A memory 240 is attached to the controller 242. The command source 270 is also attached to the controller 242. The controller 242 is communicatively coupled to the command source 270. The command source 270 can be a variety of information sources such as a personal computer, work station, or server, to name a few, that provide image information to the controller 242 by way of a data link 274. The data link 274 may be any one of a variety of data links such as an electrical link, radio frequency link, or an infrared link. The data link transfers information between the command source 270 and the imaging apparatus 110. The command source 270 can also include commands for copying files, printing from memory 240 such as a hard drive that is integral to the device, or printing a faxed file sent via phone line, or similar commands. The imaging apparatus 110 includes the entire schematic arrangement shown in FIG. 2. Generally, the dotted line box, designated by the reference number 210, includes the components associated with the imaging apparatus 110.

The controller 242 controls the transfer of information between the command source 270 and a plurality of printheads 230, 231, 232 and 233 in the print zone 128 of the imaging apparatus. The controller 242, in some embodiments of the invention, can monitor pigment type and pigment color in a plurality of reservoirs 220, 221, 222, and 223. The memory 240 also contains information as to the levels of pigment within the various reservoirs 220, 221, 222, 223. In some embodiments, a fluid level sensor 2201, 2211, 2221, and 2231 is located to monitor the level of each of the various reservoirs 220, 221, 222, 223, respectively. The fluid level determined by the fluid level sensor 2201, 2211, 2221, and 2231 is placed into memory 240. Electrical contacts associated with each of the reservoirs 220, 221, 222, 223 receive signals over conductive paths represented by the line 250. It should be noted that only four printheads are shown in the schematic of FIG. 2 and that in other embodiments of this invention there may be many more printheads in the print zone 128. In the case of a monochrome printer, there may be only one printhead in the print zone. Thus the controller 242 is capable of determining the amount of pigment used at various points in the printing process. In addition, the memory can store the cost associated with an amount of pigment in each of the reservoirs 220, 221, 222, 223.

Various parameters can be stored in the storage device or memory 240, including an actual count of pigment drops emitted from a particular printhead 230, 231, 232, 233, when the printheads are inkjets. Data is associated with a pigment reservoir or container 220, 221, 222, 223, as well as the pigment type and color, the container size, the age of the pigment, the printer model or identification number, and cartridge usage information. In other embodiments, a print command includes an indication of the paper type and information can be obtained from the print command regarding the type of print media being used. For example, in embodiments of printers where multiple paper trays are available, the type of print media must be designated as relating to a particular tray. In other embodiments, the resolution setting indicates that high-quality photo type print media is being used. The parameters listed above are just examples of the listings of parameters storable within the memory 240.

The controller 242 also controls other aspects of the imagining apparatus 110. For example, the controller 242 controls the source of the media used for a print job. An imaging apparatus, in some embodiments, is outfitted with a plurality of input media tray. A print command includes an indication of the paper type to be used for a print job. The controller 242, and specifically stored in memory 240, is the various types of papers and their association with various print trays. Therefore, in fulfilling a print command, the controller designates the print tray having the appropriate type of media or paper required by the print job. The costs of the various media can also be stored within memory 240 so that the cost associated with a print job can be determined from information in the print job, or information regarding the paper tray used for a print job and the associated cost with the media used. In addition, the memory can hold an amortized cost as well as the number of pages that can be printed over the time of amortization. Therefore an amortized cost related to the costs of wear and tear on the printing device per sheet of media can be determined by the controller 242 using information stored in the memory 240 as well as a count of the number of pages associated with a print job.

The controller 242 can be either a microprocessor, a computer system, or a dedicated controller. Many times the controller 242 is associated with an information handling system that is any device that stores, manipulates or handles information such as data. An imaging apparatus 110 is described in FIGS. 1 and 2. It should be noted that the high-speed printer is one example of a printer. The invention is also applicable to all other types of printers.

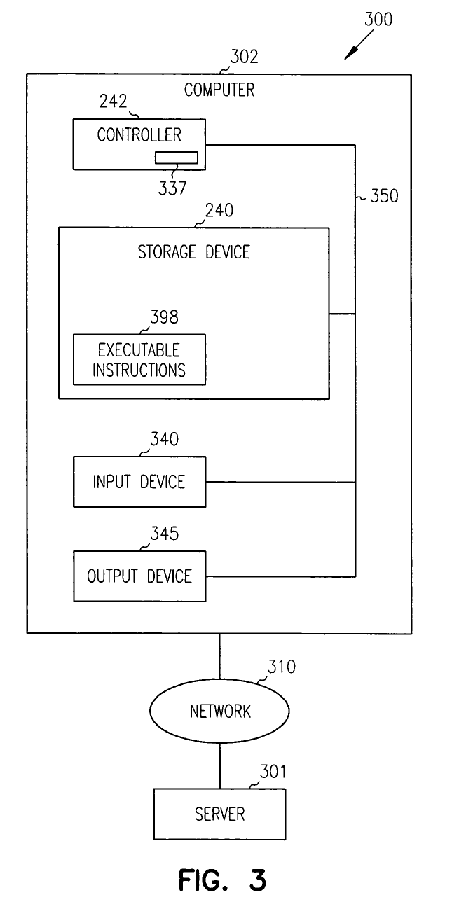

FIG. 3 is a schematic diagram of an electronic device 300 that includes the controller 242 and memory 240, according to an embodiment of the invention. The electronic device 300 includes a computing system 302 according to an embodiment of this invention. The computing system 302 includes the controller 242 and a storage device or memory 240. The storage device 240 includes computer readable and executable instructions 398. The executable instructions 398 are stored within the storage device 240. In one embodiment, the computing system 302 is integrated into an imaging apparatus 110 that includes readable computer instructions used by the controller 242 for various operations. The computing system 302 may be entirely within the imaging apparatus 110 or a portion of the computing system 302 maybe within the imaging apparatus 110. The electronic device 300 also includes a network 310 and a server 301. The computing system 302 is communicatively coupled to the network 310. The network 310 and the computing system 302 are communicatively coupled to the server 301. Other peripheral devices can also be attached to the network 310.

The controller 242 represents a central processing unit of any type of architecture, such as a CISC (Complex Instruction Set Computing), RISC (Reduced Instruction Set Computing), VLIW (Very Long Instruction Word), or a hybrid architecture, although any appropriate processor may be used. The controller 242 executes instructions and includes that portion of the electronic device 301 that controls the operation of the entire electronic device. The controller 242 typically includes a control unit 337 that organizes data and program storage in memory and transfers data and other information between the various parts of the electronic device 301. The controller 242 receives input data from the input device 340 and the network 310, reads and stores code and data in the storage device 240, and presents data to an output device 345 and/or the network 310.

Although the electronic device 300 is shown to contain only a single controller or processor 242 and a single bus 350, the present invention applies equally to electronic devices that may have multiple processors and multiple buses with some or all performing different functions in different ways.

The memory or storage device 240 represents one or more mechanisms for storing data. For example, the storage device 240 may include read only memory (ROM), random access memory (RAM), magnetic disk storage media, optical storage media, flash memory devices, and/or other machine-readable media. In other embodiments, any appropriate type of storage device may be used. Although only one storage device 240 is shown, multiple storage devices and multiple types of storage devices may be present, and in various embodiments some or all of the product codes, the control unit 337, and the products may be stored on the same or on different storage devices. Further, although the electronic device 100 is drawn to contain the storage device 240, it may be distributed across other electronic devices, for example on computers attached to the network 310.

The control unit 337 includes instructions capable of being executed on the controller or processor 242 to carry out the functions of the present invention.

The input device 340 may be a keyboard, mouse or other pointing device, trackball, touchpad, touchscreen, keypad, microphone, voice recognition device, data recorder, data recognition device or any other appropriate mechanism for the user to input data to the electronic device 300. Although one input device 340 is shown, in another embodiment any number (including none) and type of input devices may be present.

The output device 345 is that part of the electronic device 300 that communicates output to the user. The output device 345 may be a cathode-ray tube (CRT) based video display. But, in other embodiments the output device 345 may be replaced with a liquid crystal display (LCD) based or gas, plasma-based, flat-panel display. In another embodiment, the output device 345 may be a speaker. In still other embodiments, any appropriate output device may be used. Although one output device 345 is shown, in other embodiments, any number (including none) of output devices of different types or of the same type may be present.

The bus 350 may represent one or more busses, e.g., PCI, ISA (Industry Standard Architecture), X-Bus, EISA (Extended Industry Standard Architecture), or any other appropriate bus and/or bridge (also called a bus controller).

The electronic device 300 may be implemented using any suitable hardware and/or software, such as a personal computer. Portable computers, laptop or notebook computers, PDAs (Personal Digital Assistants), pocket computers, telephones, pagers, appliances, and mainframe computers are examples of other possible configurations of the electronic device 301. The hardware and software depicted in FIG. 3 may vary for specific applications and may include more or fewer elements than those depicted. For example, other peripheral devices such as audio adapters, or chip programming devices, such as EPROM (Erasable Programmable Read-Only Memory) programming devices may be used in addition to or in place of the hardware already depicted.

The network 310 may be any suitable network and may support any appropriate protocol suitable for communication between the electronic device 300 and other electronic devices. In an embodiment, the network 310 may support wireless communications. In another embodiment, the network 310 may support hard-wired communications, such as a telephone line or cable. In another embodiment, the network 310 may support the Ethernet IEEE (Institute of Electrical and Electronics Engineers) 802.3x specification. In another embodiment, the network 310 may be the Internet and may support IP (Internet Protocol). In another embodiment, the network 310 may be a local area network (LAN) or a wide area network (WAN). In another embodiment, the network 310 may be a hotspot service provider network. In another embodiment, the network 310 may be an intranet. In another embodiment, the network 310 may be a GPRS (General Packet Radio Service) network. In another embodiment, the network 310 may be any appropriate cellular data network or cell-based radio network technology. In another embodiment, the network 310 may be a wireless network. In still another embodiment, the network 310 may be any suitable network or combination of networks. Although one network 310 is shown, in other embodiments any number of networks (of the same or different types) may be present.

Aspects of an embodiment pertain to specific apparatus and method elements implementable on a computer or other electronic device. In another embodiment, the invention may be implemented as a program product for use with an electronic device. The programs defining the functions of this embodiment may be delivered to an electronic device via a variety of signal-bearing media, which include, but are not limited to:
(1) information permanently stored on a non-rewriteable storage medium, e.g., a read-only memory device attached to or within an electronic device, such as a CD-ROM readable by a CD-ROM drive;
(2) alterable information stored on a rewriteable storage medium, e.g., a hard disk drive or diskette; or
(3) information conveyed to an electronic device by a communications medium, such as through a computer or a telephone network, including wireless communications.
   Such signal-bearing media, when carrying machine-readable instructions that direct the functions of the present invention, represent embodiments of the present invention.

The imaging apparatus 110, and the electronic apparatus 300 associated with the imaging apparatus (as described in FIGS. 1-3) form a system for allocating costs associated with operation of the imaging apparatus. The system for allocating costs includes the storage device or memory 240 storage system for storing information about a cost per sheet of media associated with the imaging apparatus, and the cost of pigment associated with the imaging apparatus. The computing system 302 including the memory or storage device 240 receives a print job and records the actual number of sheets of media used to execute the print job, and records an amount of pigment used on each sheet of media for execution of the print job. The processor or controller 242 multiplies the actual number of sheets of media used by the cost per sheet of media and adds the cost of pigment for each of the pages to determine a cost associated with the print job. The processor or controller 242 also allocates the cost of the print job to an entity.

In some embodiments, the storage device 240 stores the cost of the pigment as a cost per dot of pigment. When the printer is a laser toner printer or other toner-based printer, the cost per dot of pigment varies with the density of the dots to be printed. The processor or controller 242 records the number of dots per page and multiplies the number of dots on a particular page by the cost per dot to determine the cost of pigment per page. The cost per dot of pigment varies as a function of the density of dots on a page varies. The storage device 240 stores the varying cost per dot and related dot densities per page. The storage device 240 also stores amortized costs associated with each sheet of media. The processor or controller 242 adds the amortized cost per sheet of media to the cost of the sheets of media and the cost of the pigment. Allocating the cost of the print job to an entity includes storing a billing code in the data storage system that is associated with an entity. The processor 242 reads a billing code associated with the print job and allocates the cost of the print job to the entity associated with the billing code. The billing code is embedded as part of the driver data stream associated with the print job. When a user requests a print job, a window opens on the user interface and asks the user to enter billing information. This billing information becomes a billing code in a field associated with the print job.

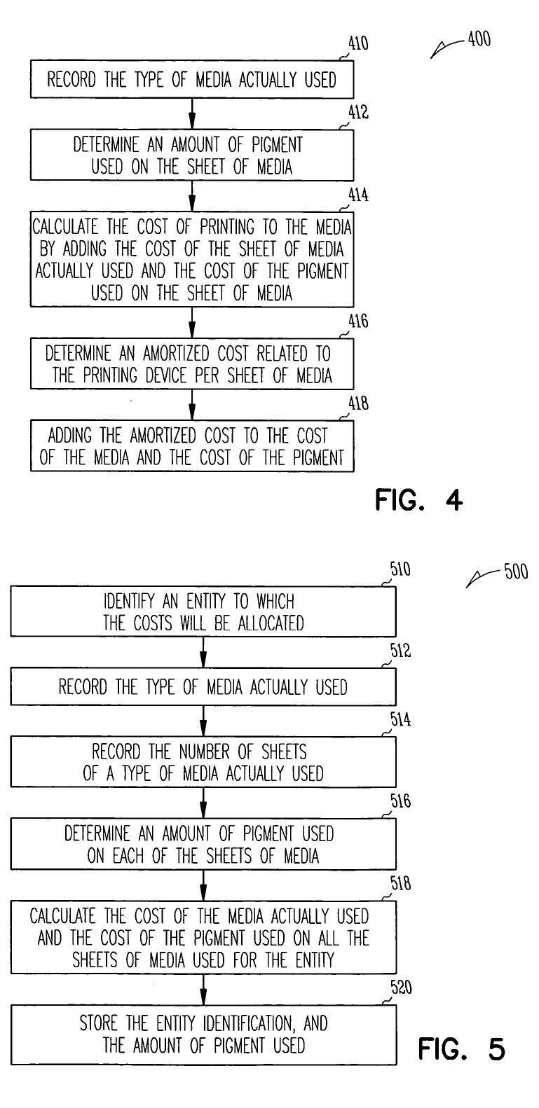

FIG. 4 is a flow chart illustrating a method of accounting 400 for printing to a sheet of media in a printing device according to an embodiment of this invention. The method of accounting for printing to a sheet of media in a printing device 400 includes recording the type of media actually used 410, determining an amount of pigment used on the sheet of media 412, and calculating the cost of printing to the media 414. Calculating the cost of printing to the media includes adding the cost of the sheet of media actually used and the cost of the pigment used on the sheet of media. The method of accounting for printing to a sheet of media also includes determining an amortized cost related to the printing device per sheet of media 416, and adding the amortized cost to the cost of the media and the cost of the pigment 418. The total cost can then be allocated to an entity. It should be noted that the cost per sheet is just one basis for amortization of costs. Other bases exist for amortizing costs including based on drum usage or printer cartridge usage, for example.

FIG. 5 is a flow chart illustrating a method of accounting for costs of printing 500 according to another embodiment of this invention. The method of accounting costs for use of a printing device 500 includes identifying an entity to which the costs will be allocated 510, recording the type of media actually used 512, recording the number of sheets of a type of media actually used 514, determining an amount of pigment used on each of the sheets of media 516, and calculating the cost of the media actually used and the cost of the pigment used on all the sheets of media used for the entity 518. The method 500 also includes storing the entity identification, the type of media, the number of sheets of media of a particular type and the amount of pigment used 520. The method 500 includes storing the amount of pigment used for each of the number of sheets of media in a print job.

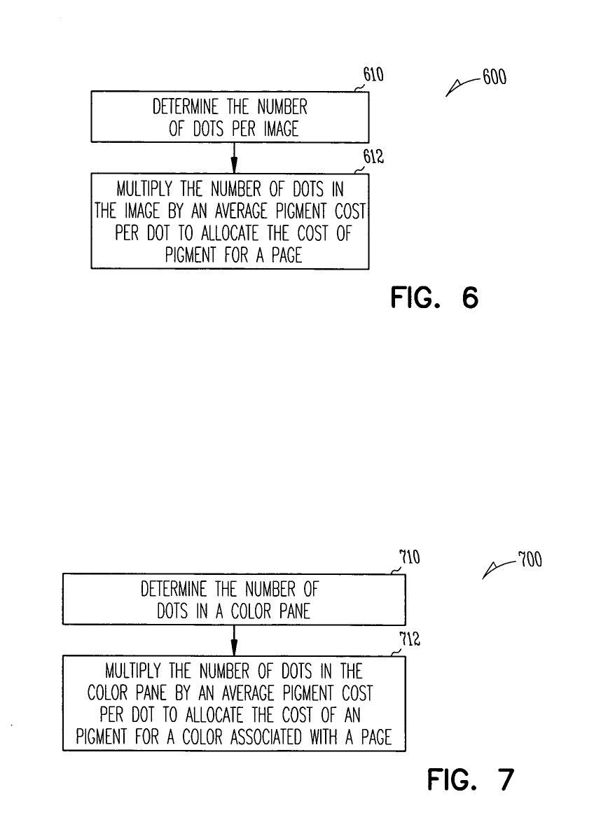

FIG. 6 is a flow chart illustrating a method of determining an amount of pigment used for printing 600, according to another embodiment of this invention. An image on a sheet is actually comprised of a number of dots that are arranged on the sheets to form an image. When a sheet is printed, the print-head or printer-heads are actually commanded to output a specific number of dots on the sheet. These dots are arranged by moving a print-head or inkjet over the sheet. The amount of pigment used to form a dot is known by keeping a statistical average over time. It should be pointed out that different colored pigments may have different costs. For example, cyan pigment will generally be more expensive than black pigment. Determining the amount of pigment used (516 in FIG. 5) includes determining the number of dots per sheet 610, and multiplying by an average pigment cost per dot to allocate the cost of pigment for a sheet 612. In some embodiments the average pigment cost per dot differs in response to the density of dots on the sheet. The average pigment cost per dot increases in response to an increase in density of dots on the sheet.

FIG. 7 is a flow chart illustrating a method of determining an amount of pigment used for printing 700, according to another embodiment of this invention. As mentioned above, an image is comprised of a number of dots. A color image is comprised of a plurality of color panes which are over laid with one another to form a colored image. A colored image will have a cyan color pane, a magenta color pane, a yellow color pane and a black color pane. Each color pane includes a number of dots associated with the color pane. Of course, the cost of different pigments associated with the different color panes may be different. The dots from various color panes can be set in single dot or beside one another to form different colors. As shown in FIG. 7, determining the amount of pigment used further includes determining the number of dots in a color pane 710, and multiplying the number of dots in the color pane by an average pigment cost per dot to allocate the cost of an pigment for a color associated with a page 720. The average pigment cost per page or sheet differs in response to the density of dots on the color pane in toner-based printing systems. The average pigment cost per color pane increases in response to an increase in density of dots on the color pane. In some embodiments there is only one color pane. In other embodiments there are a plurality of color panes. The method of determining the amount of pigment used can include determining the number of dots in a first color pane, and multiplying the number of dots in the first color pane by an average pigment cost per dot to allocate the cost of a pigment for a first color associated with a page. The number of dots in a second color pane are determined, and the number of dots in the second color pane is multiplied by an average pigment cost per dot to allocate the cost of a pigment for a second color associated with a page.

Identifying an entity to which the costs will be allocated includes entering a billing code associated with the entity. A billing code can be associated with the entity and with a print job. The cost of amortization of the printing device can also be added to the cost of the media and the cost of the pigment.

FIG. 8 is a flow chart illustrating a method of accounting for costs of printing 800 according to another embodiment of this invention. The method of accounting for the use of pigment in a printing device 800 includes separating the print job into a first color pane and a second color pane 810, determining the number of dots in a first color pane 812, multiplying the number of dots in the first color pane by an average pigment cost per dot to allocate the cost of a pigment for a first color associated with a page 814, determining the number of dots in a second color pane 816, and multiplying the number of dots in the second color pane by an average pigment cost per dot to allocate the cost of a pigment for a second color associated with a page 818. The average pigment cost per sheet of the first pigment varies in response to the density of dots on the first color pane. The average pigment cost per sheet of the first pigment increases as the density of the dots increases. The average pigment cost per color pane of the first pigment varies in response to the density of dots on the first color pane, and average pigment cost per color pane of the second pigment varies in response to the density of dots on the second color pane.

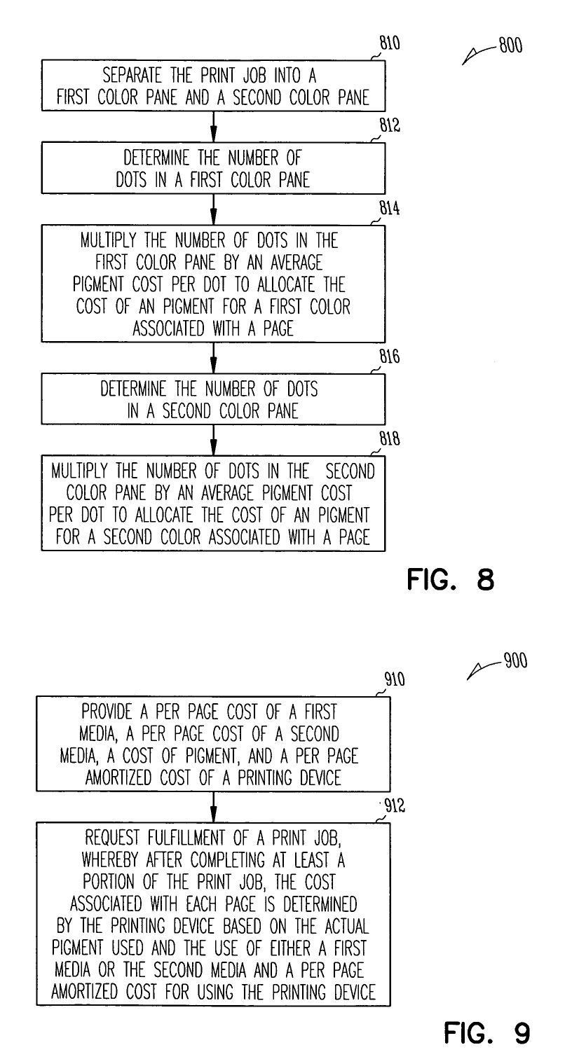

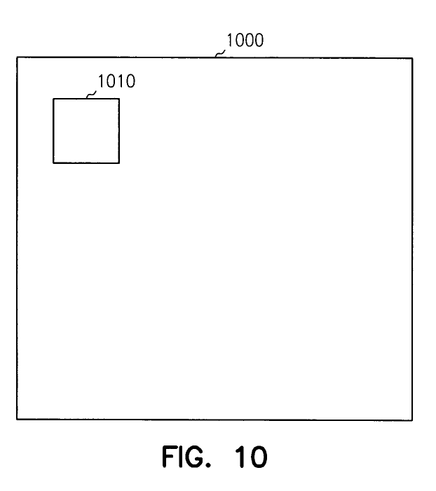

FIG. 9 is a flow chart illustrating a method of accounting for costs of printing 900 according to another embodiment of this invention. The method for determining the costs associated with a print job 900 includes providing a per page cost of a first media, a per page cost of a second media, a cost of pigment, and a per page amortized cost of a printing device 910, and requesting fulfillment of a print job, whereby after completing at least a portion of the print job, the cost associated with each page is determined by the printing device based on the actual pigment used and the use of either a first media or the second media and a per page amortized cost for using the printing device 912. Although a first or second media are discussed, it should be noted that there may be any number of media. Each of the methods discussed above can be implemented as an instruction set on a computer-readable medium. FIG. 10 is a block diagram of a computer-readable medium 1000 that includes an instruction set 1010 therein. The computer-readable medium can be any type of memory, a disk used for magnetic disk storage, optical disk storage, flash memory devices, or other machine-readable media. Media can also be read-only memory or random-access memory, which is part of a hardware configuration for a computer system. Furthermore, the media can also include the internet, storage available to a server, or a transmission of any sort, connected or wireless, that is used to transmit the instructions to the controller 242 or some other processor/computer.

A computer program product for use with a computer associated with a printing device, the computer program product includes a computer usable medium 1000 having a set of instructions 1010 for causing the computer to determine the number of dots in a first pane of a page of a print job, and multiply the number of dots in the first pane by an average pigment cost per dot to determine the cost of a pigment associated with the first pane of a page. The instructions further cause the computer to record a type of media actually used, and calculate a cost of the pigment used of the media. The instructions further cause the computer to amortize the cost of the printing device on a per media sheet basis and add the amortized cost to the cost of the pigment and the cost of the media. In some embodiments, the instructions further cause the computer to determine the number of dots in a second pane of a page of a print job, and multiply the number of dots in the second pane by an average pigment cost per dot to determine the cost of a printer associated with the second pane of a page, record a type of media actually used, and calculate a cost of the pigment used on a cost of the media.

In the previous detailed description of exemplary embodiments of the invention, reference was made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. Different instances of the word “embodiment” as used within this specification do not necessarily refer to the same embodiment, but they may. The previous detailed description is, therefore, not to be taken in a limiting sense, and the scope of the present invention is defined only by the appended claims.

In the previous description, numerous specific details were set forth to provide a thorough understanding of the invention. However, it is understood that the invention may be practiced without these specific details. In other instances, well-known circuits, structures, and techniques have not been shown in detail in order not to obscure the invention.

Although specific embodiments have been illustrated and described herein, those of ordinary skill in the art will appreciate that any arrangement calculated to achieve the same purpose can be substituted for the specific embodiments shown. This disclosure is intended to cover any and all adaptations or variations of various embodiments of the invention. It is to be understood that the above description has been made in an illustrative fashion, and not a restrictive one. Combinations of the above embodiments, and other embodiments not specifically described herein will be apparent to those of skill in the art upon reviewing the above description. The scope of various embodiments of the invention includes any other applications in which the above structures and methods are used. Therefore, the scope of various embodiments of the invention should be determined with reference to the appended claims, along with the full range of equivalents to which such claims are entitled.

It is emphasized that the Abstract is provided to comply with 37 C.F.R. §1.72(b) requiring an Abstract that will allow the reader to quickly ascertain the nature and gist of the technical disclosure. It is submitted with the understanding that it will not be used to interpret or limit the scope or meaning of the claims.

In the foregoing Description of Embodiments of the Invention, various features are grouped together in a single embodiment for the purpose of streamlining the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus the following claims are hereby incorporated into the Description of Embodiments of the Invention, with each claim standing on its own as a separate preferred embodiment.

1. A method of accounting for printing to a sheet of media in a printing device comprising:
recording a type of media actually used;
determining an amount of pigment used on the sheet of media; and
calculating the cost of printing to the media by adding a cost of the sheet of media actually used and a cost of the pigment used on the sheet of media.

2. The method of accounting for printing to a sheet of media of claim 1 further comprising:
determining an amortized cost related to the printing device per sheet of media; and
adding the amortized cost to the cost of the sheet of media and the cost of the pigment.

3. The method of accounting for printing to a sheet of media of claim 1 further comprising:
determining an amortized cost related to an operation of the printing device; and
adding the amortized cost to the cost of the sheet of media and the cost of the pigment.

4. The method of accounting for printing to a sheet of media of claim 1 further comprising allocating the cost of printing to the media to an entity.

5. A method of accounting costs for use of a printing device comprising:
identifying an entity to which the costs will be allocated;
recording a type of media actually used for the entity;
recording a number of sheets of the type of media actually used for the entity;
determining an amount of pigment used on each of the sheets of media;
calculating a cost of the media actually used and a cost of the pigment used on all the sheets of media used for the entity; and
allocating the cost of the media actually used and the cost of the pigment used to the entity.

6. The method of claim 5 further comprising storing the entity identification, the type of media, the number of sheets of media of a particular type and the amount of pigment used.

7. The method of claim 5 further comprising storing the entity identification, the type of media, the number of sheets of media of a particular type and the amount of pigment used for each of the number of sheets of media in a print job.

8. The method of claim 5 wherein determining the amount of pigment used further comprises:
determining the number of dots needed to form an image on a sheet; and
multiplying the number of dots on the sheet by an average pigment cost per dot.

9. The method of claim 8 wherein the average pigment cost differs in response to a density of each dot on the sheet.

10. The method of claim 8 wherein the average pigment cost increases in response to an increase in a density of each dot on the sheet.

11. The method of claim 5 wherein determining the amount of pigment used further comprises:
determining the number of dots of a color used to form a color pane, the color panes overlayed with one another to form an image; and
multiplying the number of dots in the color pane by an average pigment cost per dot to allocate the cost of a pigment for a color associated with the image.

12. The method of claim 11 wherein the average pigment cost differs in response to the density of dots on the color pane.

13. The method of claim 11 wherein the average pigment cost increases in response to an increase in density of dots on the color pane.

14. The method of claim 5 wherein determining the amount of pigment used further comprises:
determining a number of dots in a first color pane; and
multiplying the number of dots in the first color pane by an average pigment cost per dot to allocate the cost of a pigment for a first color associated with a page;
determining the number of dots in a second color pane; and
multiplying the number of dots in the second color pane by an average pigment cost per dot of a second color to allocate the cost of a pigment for the second color associated with a page.

15. The method of claim 5 wherein identifying an entity to which the costs will be allocated further comprises entering a billing code associated with the entity.

16. The method of claim 5 wherein identifying an entity to which the costs will be allocated further comprises entering a billing code associated with the entity and a code associated with a print job.

17. The method of claim 5 further comprising adding a cost of amortization of the printing device to the cost of the media and the cost of the pigment.

18. A method of accounting for the use of pigment in a printing device comprising:
separating the print job into a first color pane and a second color pane;
determining a number of dots in the first color pane;
multiplying the number of dots in the first color pane by an average pigment cost per dot of a first color to allocate the cost of a pigment for the first color associated with a page;
determining a number of dots in a second color pane; and
multiplying the number of dots in the second color pane by an average pigment cost per dot of a second color to allocate the cost of a pigment for the second color associated with a page.

19. The method of claim 18 wherein the average pigment cost of the first pigment varies in response to the density of dots on the first color pane.

20. The method of claim 18 wherein the average pigment cost of the first pigment increases as the density of the dots increases.

21. The method of claim 18 herein the average pigment cost of the first pigment varies in response to the density of dots on the first color pane, and the average pigment cost of the second pigment varies in response to the density of dots on the second color pane.

22. A computer program product for use with a computer associated with a printing device, the computer program product comprising a computer usable medium having a set of instructions for causing the computer to:
determine a number of dots in a first pane of a page of a print job; and
multiply the number of dots in the first pane by an average pigment cost per dot to determine the cost of a pigment associated with the first pane of a page.

23. The computer program product for use with a computer associated with a printing device of claim 22, wherein the computer usable medium further causes the computer to:
record a type of media actually used; and
calculate a cost of the pigment used on a cost f the media.

24. The computer program product for use with a computer associated with a printing device of claim 23, wherein the computer usable medium further causes the computer to:
amortize the cost of the printing device on a per operation basis; and
add the amortized cost to the cost of the pigment and the cost of the media.

25. The computer program product for use with a computer associated with a printing device of claim 22, wherein the computer usable medium further causes the computer to:
determine a number of dots in a second pane of a page of a print job; and
multiply the number of dots in the second pane by an average pigment cost per dot to determine a cost of a pigment associated with the second pane of the page;
record a type of media actually used;
determine a cost of the media actually used; and
calculate a cost of the pigment used and a cost of the media.

26. A system for allocating costs associated with operation of a printing device comprising:
a data storage system for storing information regarding a cost per sheet of media associated with the printing device, and a cost of pigment associated with the printing device; and
a data a processing system coupled to said data storage system and operative to receive a print job and to record an actual number of sheets of media used to execute a print job and to record an amount of pigment used on each sheet of media for execution of the print job, the data processing system multiplying the actual number of sheets of media used by the cost per sheet of media and adding the cost of pigment for each of the pages to determine a cost associated with the print job, the data processing system further operative to allocate the cost of the print job to an entity.

27. The system for allocating costs according to claim 26, wherein said data storage system stores the cost of the pigment as a cost per dot of pigment, and wherein the data processing system records a number of dots per page and multiplies the number of dots on a particular page by the cost per dot to determine the cost of pigment per page.

28. The system for allocating costs according to claim 27, wherein the cost of pigment varies as a function of the density of dots on a page varies.

29. The system for allocating costs according to claim 26, wherein the data storage system also stores an amortized cost for wear on the printing device based on the number of sheets of media anticipated to be printed over the life of the printing device, the amortized cost on a per sheet of media basis, the data processing system adding the amortized cost per sheet of media to the cost of the sheets of media and the cost of the pigment.

30. The system for allocating costs according to claim 26, wherein allocating the cost of the print job to an entity includes storing a billing code in the data storage system associated with the entity, the data processing system reading a billing code associated with the print job and allocating the cost of the print job to the entity associated with the billing code.

31. A method for determining the costs associated with a print job comprising:
providing a per page cost of a first media, a per page cost of a second media, a cost of pigment, and a per page amortized cost of a printing device; and
requesting fulfillment of a print job and, after fulfilling at least a portion of the print job, the printing device determining the cost associated with each page based on the actual pigment used and the use of either a first media or the second media and a per page amortized cost for using the printing device.
